(19) United States
(12) Patent Application Publication
(10) Pub. No.: US 2016/0328709 A1
(43) Pub. Date: Nov. 10, 2016

(54) SYSTEM FOR REDUCING MEMORY USAGE IN A PRE-AUTHORIZED DEBIT MANAGER

(71) Applicant: D+H Limited Partnership, Toronto (CA)

(72) Inventors: Ettan ROMM, Toronto (CA); Lisa MCCAW, Toronto (CA)

(73) Assignee: D+H Limited Partnership, Toronto (CA)

(21) Appl. No.: 15/147,311

(22) Filed: May 5, 2016

Related U.S. Application Data
(60) Provisional application No. 62/157,300, filed on May 5, 2015.

(51) Int. Cl. G06Q 20/40; H04L 12/46; G06Q 20/14; G06Q 20/38; G06Q 20/10; G06Q 40/02

(52) U.S. Cl. CPC G06Q 20/40; G06Q 20/102; G06Q 40/02; G06Q 20/14; G06Q 20/382; H04L 12/4641

(57) ABSTRACT

An improved computerized system and method for efficiently processing and managing pre-authorized debits or payments. The system and method having a pre-authorized debit agreement authoring engine. Digitally signing the pre-authorized debit (PAD) agreement by the merchant and the client. Initiating a pre-authorized debit based on the terms of the PAD agreement.

This application claims the benefit of U.S. Provisional Application No. 62/157,300, filed May 5, 2015, the contents of which are herein expressly incorporated by reference in its entirety.

### FIELD OF THE INVENTION

The present invention relates generally to an improved computerized system and method for efficiently processing and managing payments. More particularly, the present invention relates to a method and system of efficiently managing and processing pre-authorized debits or payments.

### BACKGROUND OF THE INVENTION

U.S. Pat. No. 8,538,868, herein incorporated by reference in its entirety, to Davis+Henderson, Limited Partnership, the applicant of the present invention, describes a system and method of preparing a transfer document for a client to transfer services provided by counterparties that require recurring transactions using a first account to use a second account is provided. A cashflow analysis for the first account and a cashflow analysis for the second account are performed to determine for each counterparty and each service the desired date to effect the transfer to avoid undesirable cashflow spikes or interruptions in both accounts. A transfer document for transferring services requiring recurring transactions for each counterparty is electronically generated via at least one computer. Each transfer document identifies at least the service to be transferred, the client, the second account, the desired date for the transfer and proof of authorization from the client. A replica of an account document selected according to the service being transferred and the second account is included on the transfer document.

U.S. Pat. No. 7,716,124, herein incorporated by reference in its entirety, to Davis+Henderson, Limited Partnership, the applicant of the present invention, describes a system and method of assisting a client transfer financial services using a first account to a second account collects relevant information and authorization from the client. The system and method maintains a database of counterparties providing services to clients of financial institutions and uses the information provided by the client and information in the database of counterparties to schedule and effect the transfer of the services. The system and method creates the necessary transfer information for each service to be transferred and dispatches the completed transfer information to each counterparty with a desired date for the transfer to be effected, the desired dates being selected in accordance with a cashflow analysis performed by the system and method of both the account at the previous financial institution and the account at the new financial institution.

Although the systems and methods described above work well, difficulties may be experienced in providing an efficient system and method for managing and processing pre-authorized debits or payments. In particular, in managing and processing pre-authorization payments such as, for example, debit (PAD) agreements, Automated Clearing House (ACH) payment agreements, pre-authorized credit card payment agreements, or other form of pre-authorized payment agreement.

### SUMMARY OF THE INVENTION

According to one aspect of the invention, there is provided a system and method of managing pre-authorization debit agreements as further describe herein.

According to another aspect of the invention, there is provided a system for reducing memory usage in a pre-authorized debit manager comprising: a networked processing structure comprising a data power appliance executing a web service endpoint; an application server executing a payment manager; the payment manager retrieving data from a database server storing a plurality of merchant accounts, client accounts, and financial accounts; and a merchant computer providing a PAD agreement authoring engine for editing a PAD agreement. The merchant computer may access a merchant portal for retrieving at least one pre-authored clause from the merchant portal. The merchant computer may add at least one reference to the at least one pre-authored clause to the PAD agreement. The merchant computer may create a merchant digitally signed PAD agreement from the PAD agreement. The merchant computer may upload the signed PAD agreement to the merchant portal. The merchant computer may associate the merchant signed PAD agreement with a unique merchant identifier.

In yet another aspect of the invention, there is provided a client computing device comprising: a processor retrieving and executing instructions from memory; a user interface communicating with the processor; a network for communication between the processor and a payment manager; a camera communicating with the processor. The memory may comprise instructions to cause the processor to: capture an image of a bill from the camera; uploading the image to the payment manager over the network; retrieving a merchant list from the payment manager based at least on the image; displaying the merchant list on the user interface; receiving a selection from the merchant list from the user interface; retrieving a pre-authorized debit agreement from the payment manager; and retrieving at least one clause from the payment manager based on at least one reference within the pre-authorized debit agreement. The image may comprise at least one quick response code encoding bill data. The processor may verify a digital signature of the pre-authorized debit agreement. The processor may digitally sign the pre-authorized debit agreement using a client digital signature. The processor may transmit the pre-authorized debit agreement signed with the client digital signature to the payment manager.

In another aspect of the invention, there is provided a system for managing pre-authorized debits (PADs) comprising: a networked processing structure comprising a data power appliance executing a web service endpoint; an application server executing a payment manager; the payment manager retrieving data from a database server storing a plurality of merchant accounts, client accounts, and financial accounts; a merchant computer providing a PAD agreement authoring engine for editing a PAD agreement; the merchant computer accessing a merchant portal for creating a merchant signed PAD agreement from the PAD agreement; and associating the merchant signed PAD agreement with a unique merchant identifier. The system may further comprise a bank server communicating with the networked processing structure over a network. The network may be secured by a virtual private network.

The system may further comprise a client computing device accessing the banking server; the client computing device configured to pay at least one merchant bill from at least one client account. The client computing device may set up the at least one merchant bill as a pre-authorized debit. The client computing device may also retrieve the merchant signed PAD agreement. The client computing device may digitally sign the merchant signed PAD agreement; and may return the digitally signed merchant agreement to the payment manager.

The system may further comprise an agent computer accessing the online banking system communicating with the networked processing structure. The agent computer may access the at least one client account to assist in the setup of the pre-authorized debit. The payment manager may initiate a recurring debit based on one or more terms of the PAD agreement by transmitting the digitally signed merchant agreement to the merchant computer.

Although the aspects described above are described individually, the aspects may be combined as would be known to one of skill in the art.

### BRIEF DESCRIPTION OF THE DRAWINGS

An embodiment will now be described, by way of example only, with reference to the attached Figures, wherein:

FIG. 1 shows a high-level architecture of a system of managing payments;

FIG. 2 shows an architecture of a computing device that may be used to implement various parts of the invention;

FIG. 3 shows an architecture of a mobile computing device that may be used to implement various parts of the invention;

FIG. 4 demonstrates a process flow diagram for uploading the pre-authorized debit agreement;

FIGS. 5A to 5D shows a process flow diagram for signing the pre-authorized debit agreement;

FIGS. 6A and 6B demonstrate a process flow diagram for viewing the pre-authorized debit agreement;

FIG. 7 shows a process flow diagram for an agent-assisted pre-authorized debit agreement;

FIG. 8 shows a customer user interface to instruct the system to make pre-authorized debits;

FIG. 9 shows another customer interface for making automatic payments; and

FIG. 10 shows a customer interface for adding payees.

### DETAILED DESCRIPTION OF THE EMBODIMENT

While the Background of Invention described above has identified particular problems known in the prior art, the present invention provides at least, in part, a new and useful application for managing and processing pre-authorization payments.

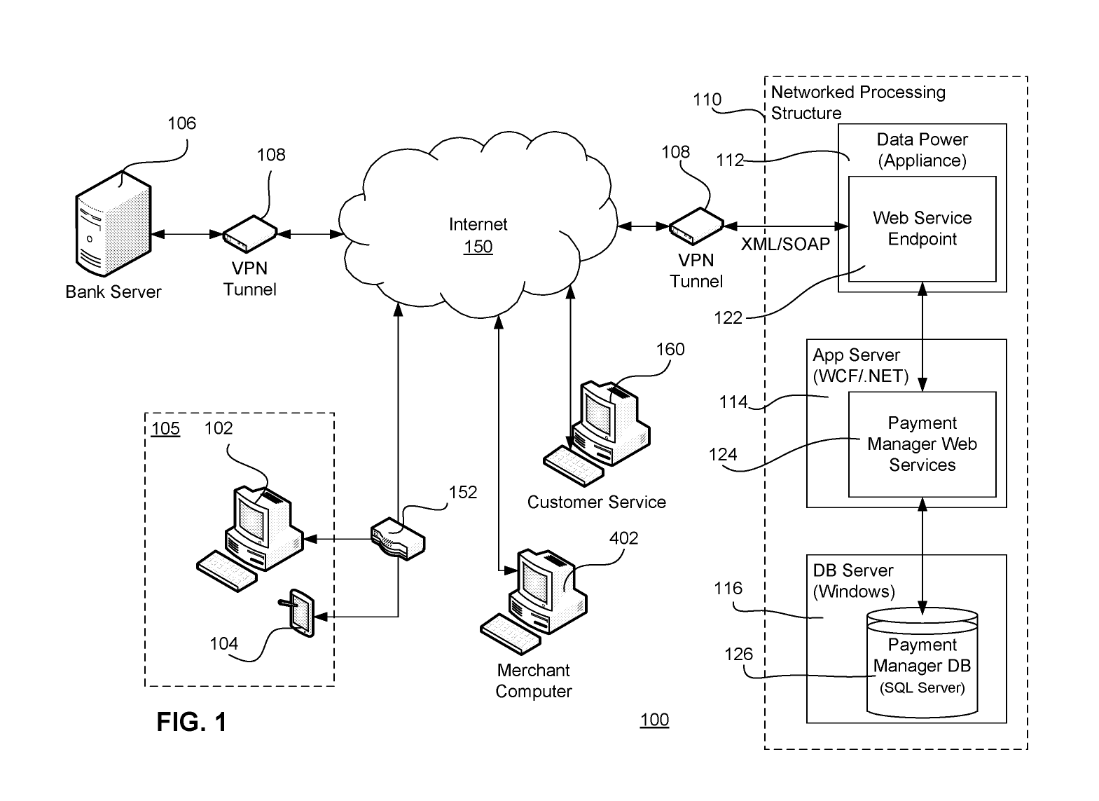

FIG. 1 demonstrates a high-level hardware architecture 100 of the present embodiment. A user operates a user computing device 105 which may be a mobile device 104 such as a smartphone, a tablet computer, or laptop or a conventional computer system 102. The user computing device 105 may communicate over a wired or wireless access point 152. The wireless access point 152 may communicate using any number of wireless communication protocols such as 3G, LTE, WiFi, Bluetooth® or other wireless communication channels known in the art. The access point 152 allows the user computing devices 105 to communicate with other devices over the Internet 150. These computing devices 105 may request a web-based interface from one or more bank servers 106 using a secure hypertext transport protocol (HTTPS). The web-based interface presents the user with a login screen where the user is authenticated in order for the computing device 105 to access one or more financial accounts. This communication typically is conducted using only HTTPS but may use other secure protocols or a Virtual Private Network (VPN) tunnel 108.

The bank server 106 may redirect the request of the computer device 105 to a third party provider of web services operating a networked processing structure 110. In this embodiment, the redirection occurs over a VPN tunnel 108. The networked processing structure 110 comprises a data power appliance 112, an application server 114, and a database server 116. The networked processing structure 110 is not limited by the number of servers and may comprise more servers in order to, for example, balance processor and/or network load.

The data power appliance 112 executes a web service endpoint 122 that receives eXtensible Markup Language (XML) and/or Simple Object Access Protocol (SOAP) data from the bank server 106. The web service endpoint 122 maps the received data via a service call containing details that reference a web service to return the appropriate data or messages for presentation in an online banking interface. Based on the service call, the web service returns raw data for the financial institution to interpret and display to their customer via the appropriate web service. The mapping of the received data may pass the data to a payment manager web service 124 executing as a NET framework or Windows

Communication Foundation application on the application server 114. The payment manager web service 124 provides clients, merchants, and financial institutions the ability to manage their pre-authorized payments. The payment manager web service 124 retrieves merchant data including details such as merchant name, address, accepted payment types, account format hints and tips, etc. from a payment manager database 126, which in this embodiment is a Structured Query Language (SQL) database or other type of database known in the art.

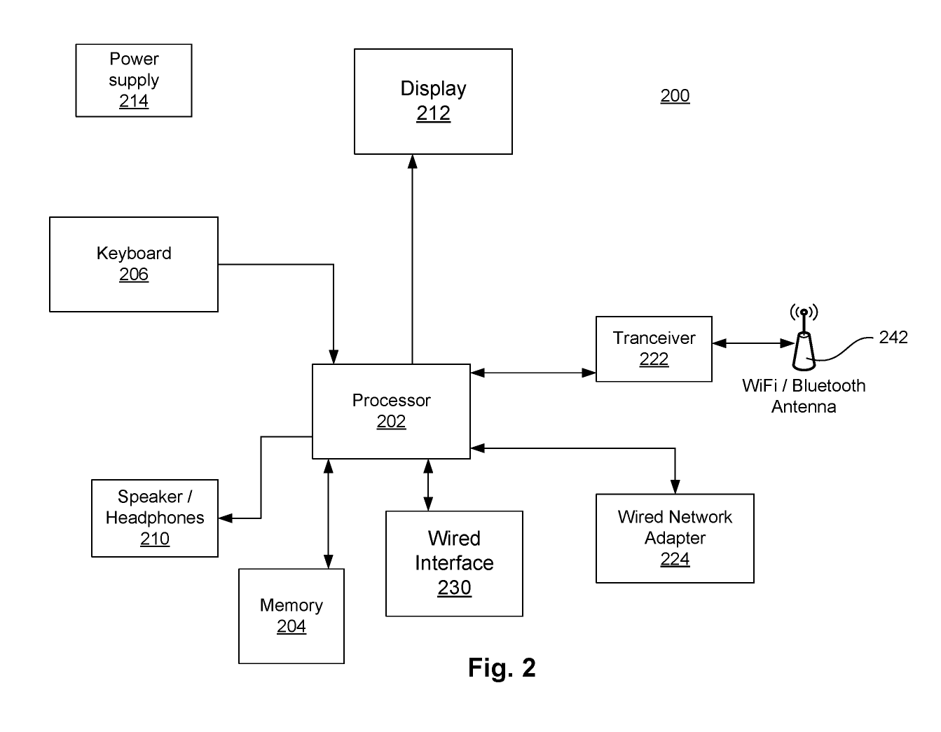

The components 200 of an example bank server 106 is further disclosed in FIG. 2 having a processor 202, which may be a single core or multi-core processor, executing instructions from volatile or non-volatile memory 204 and storing data thereto. The memory 204 may also comprise a long-term storage device such as a hard disk drive or solid state disk drive. The bank server 106 may have a number of human-computer interfaces such as a keyboard or touch screen 206, a speaker or headphones 210, and a display 212. The keyboard 206 could be a conventional keyboard found on most computers. The keyboard 206 could be a standard-sized 101-key or 104-key keyboard, a laptop-sized keyboard lacking a number pad, a handheld keyboard, a thumb-sized keyboard or a chorded keyboard known in the art. Alternatively, the bank server 106 may be rack mounted and not have any human-computer interfaces. The bank server 106 communicates with the data power appliance 112, and application server 114 via the Internet 150. The bank server 106 may have a wired interface 230 such as a universal serial bus (USB) or other type of wired interface for communicating with hardware devices. The processor 202 of the bank server 106 communicates with the Internet 150 via a wired network adapter 224 such as an Ethernet adapter operating at speeds of 10, 100, or 1000 Mbps. Alternatively, the processor 202 may communicate using a wireless transceiver 222 transmitting wireless signals over an antenna 242. The bank server 106 has a power supply 214 supplying power to all the components 200.

The VPN tunnel 108 may execute on the processor 202 or wired network adapter 224 of the bank server 106 or, as in this embodiment, may be a dedicated security device 108 having its own processor, network interfaces, and memory.

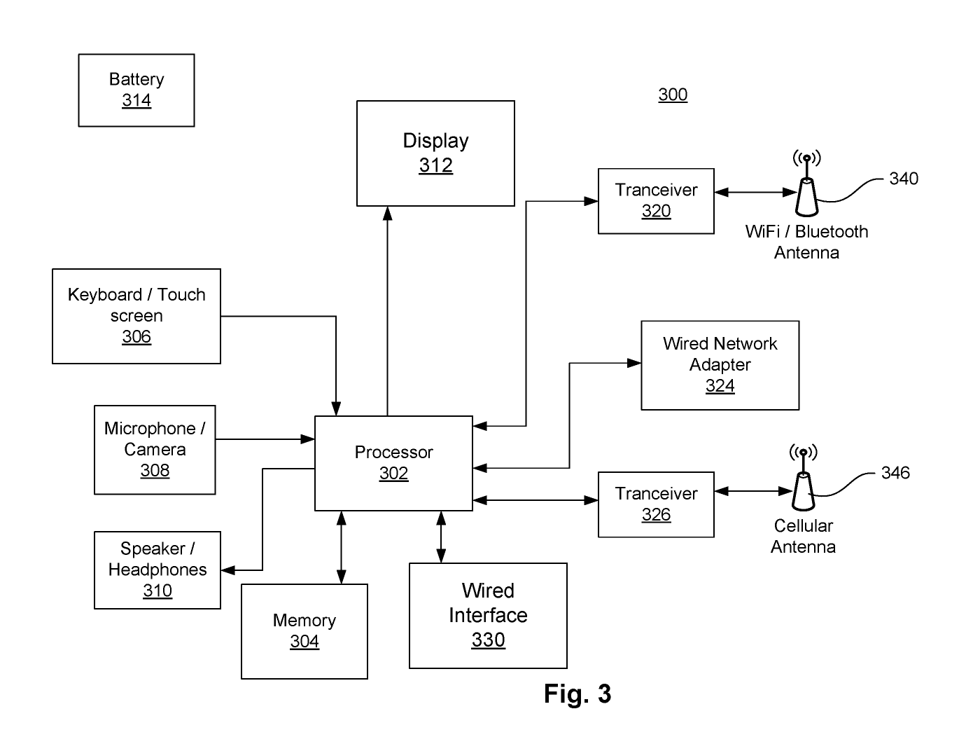

The components 300 of the user computing device 105 are described in more detail with respect to FIG. 3. The user computing device 105 has a processor 302, which may be a single core or multi-core processor, executing instructions from volatile or non-volatile memory 304 and storing data thereto. The memory 304 may also comprise a long-term storage device such as a hard disk drive or solid state disk drive. The computing device 105 has a number of human-computer interfaces such as a keyboard or touch screen 306, microphone and/or camera 308, a speaker or headphones 310, and a display 312. The keyboard 306 could be a conventional keyboard found on most computers. The keyboard 306 could be a standard-sized 101-key or 104-key keyboard, a laptop-sized keyboard lacking a number pad, a handheld keyboard, a thumb-sized keyboard or a chorded keyboard known in the art. A power supply 314 such as a battery supplies power to all the components 300.

The processor 302 of the computing device 105 may communicate with the bank server 106 using a transceiver 320 which sends signals through an antenna 340, in this embodiment, the antenna 340 and transceiver 320 are using a WiFi and/or Bluetooth protocol. Alternatively, the processor 302 may use a wired network adapter 324. The processor 302 may also have a transceiver 326 and cellular antenna 346 for cellular communications.

The agent computing device 160 and merchant computing device 170 may comprise similar components as the user computing device 105 and will not be further described herein.

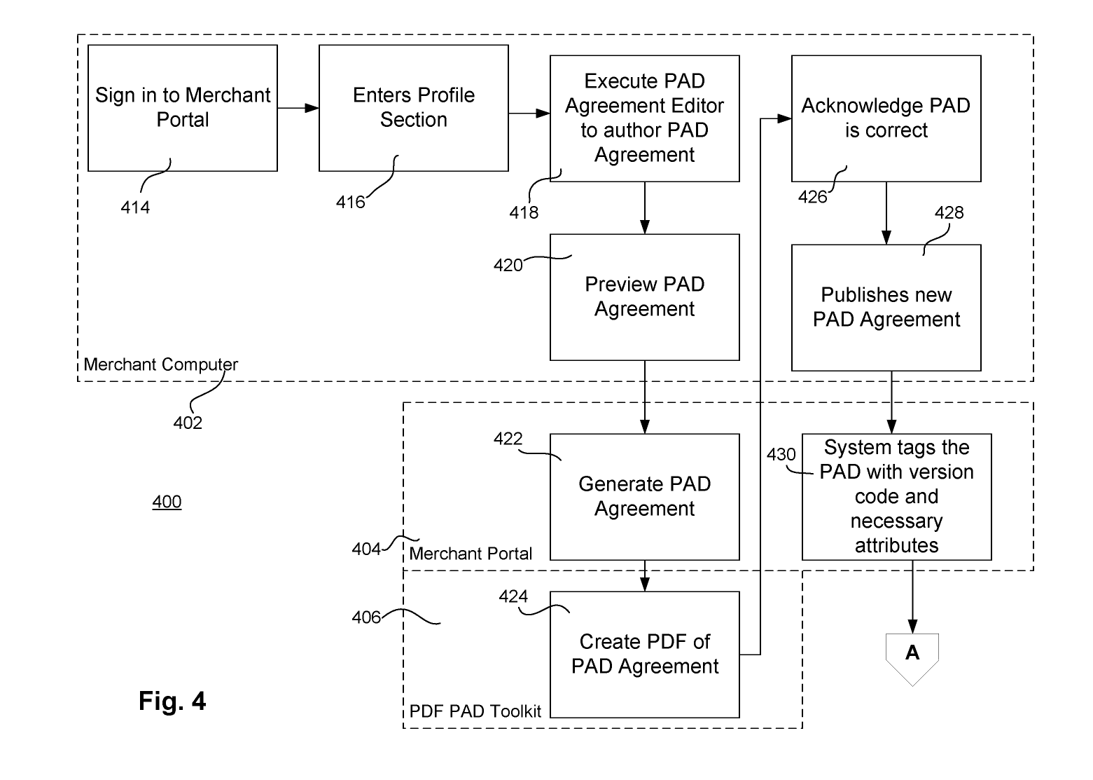

FIG. 4 demonstrates a computerized system 400 for authorizing and generating a pre-authorized debit (PAD) agreement. The merchant signs into a merchant portal 404 using a merchant computer 402 using a merchant identifier and password (step 414).

Alternatively, the merchant may sign in using a digital signature or other form of authentication such as SmartCard, RFID, etc via an suitable reader. The data power appliance 112 redirects the request to a merchant portal 404 specifically designed for merchant interaction. The payment manager web services 124 allocates memory within the network processing structure 110 and executes instructions to generate the merchant portal 404. The interface of the merchant portal 404 is delivered to the merchant computer 402 over the Internet 150, optionally via a VPN tunnel 108. The merchant then enters a profile section (step 416) where the merchant interface presents the merchant with a list of options, one of which is to author a PAD agreement. When the merchant selects the PAD Agreement Editor, the merchant portal 404 delivers an editor interface specifically designed for editing PAD Agreements (step 418). Optionally, the editor interface may start with a default PAD agreement or may use an inquiry engine that asks the merchant specific questions about the limitations of the PAD agreement. The data input to the inquiry engine may then be used to automatically modify the text and/or graphical data of the PAD agreement. The merchant may select particular pre-authored clauses or sections of previously authored PAD agreements in order to more quickly and efficiently author the PAD agreement. Moreover, memory requirements may be reduced for each PAD agreement as the PAD may refer to the text of the pre-authored clauses or sections by reference.

Once the merchant is satisfied with the PAD agreement, the merchant may select to preview the PAD Agreement (step 420). The merchant computer 402 then instructs the merchant portal 404 to generate the PAD Agreement (step 422). The payment manager web services 124 also provides a PAD toolkit 406 that the merchant portal 404 may execute in order to create digitally secured Postscript Data Format (PDF) of PAD Agreements (step 424). The PDF PAD Agreement is then transmitted over the Internet 150 to the merchant computer 402 where it is displayed and/or printed. The merchant may then acknowledge that the PDF PAD agreement is correct (step 426) or returns to authoring the agreement (step 418). The acknowledgment is transmitted to the merchant portal 404 instructing the merchant portal 404 to publish the PAD Agreement to the merchant account (step 428) associated with the merchant identifier. The merchant portal 404 then tags the PAD agreement with a version code and attributes (step 430) such as customer name, customer address, customer FI, customer Transit #, customer Account number plus the digital timestamp of acceptance of the PAD agreement which includes the date and time, customer name and IP address or other information dictated by the Canadian Payments Association Rule H1, herein incorporated by reference or other payment standard.

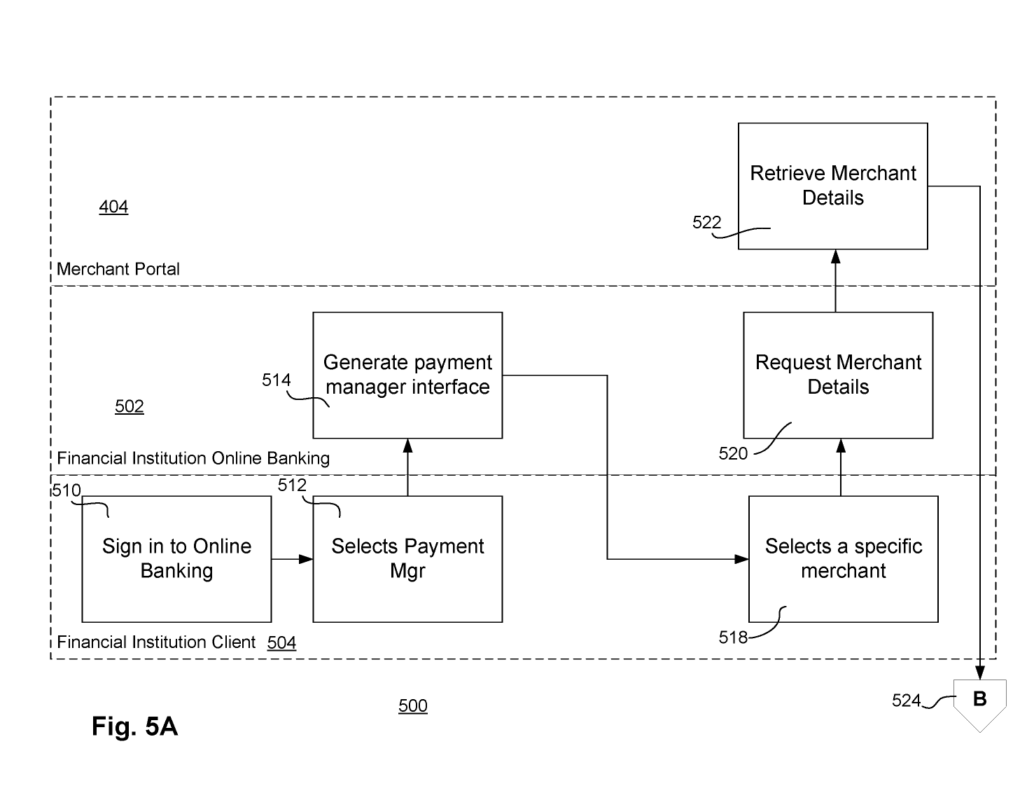

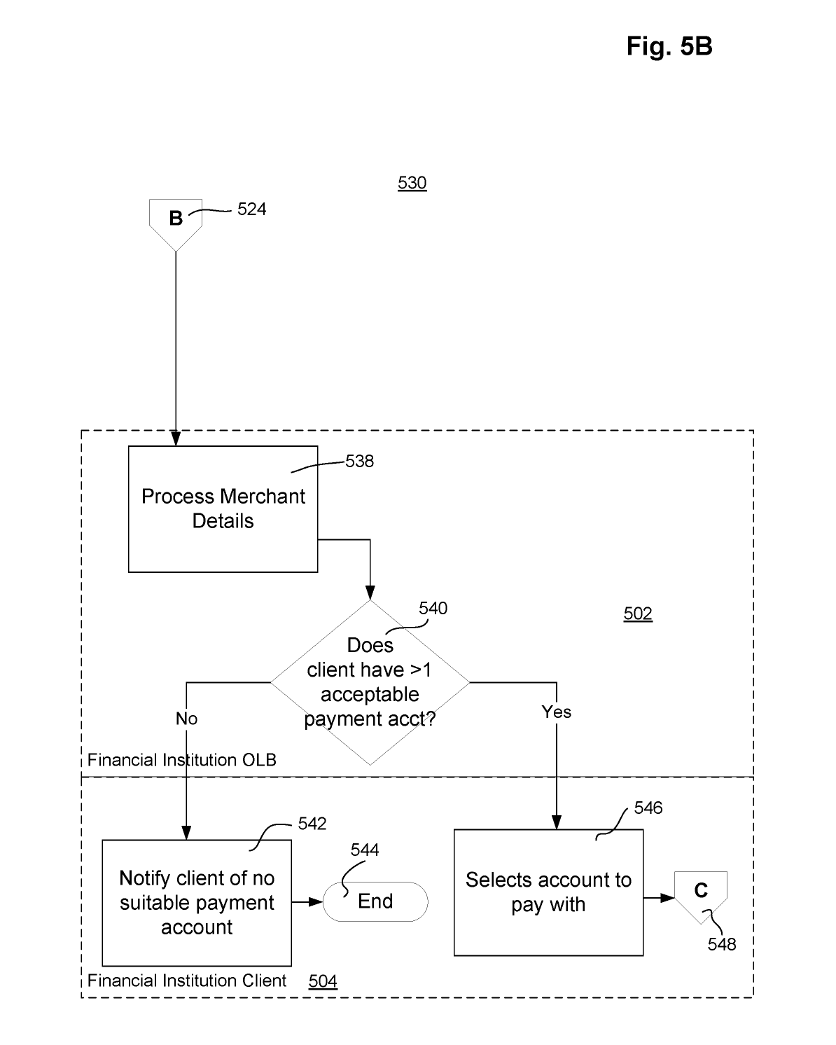

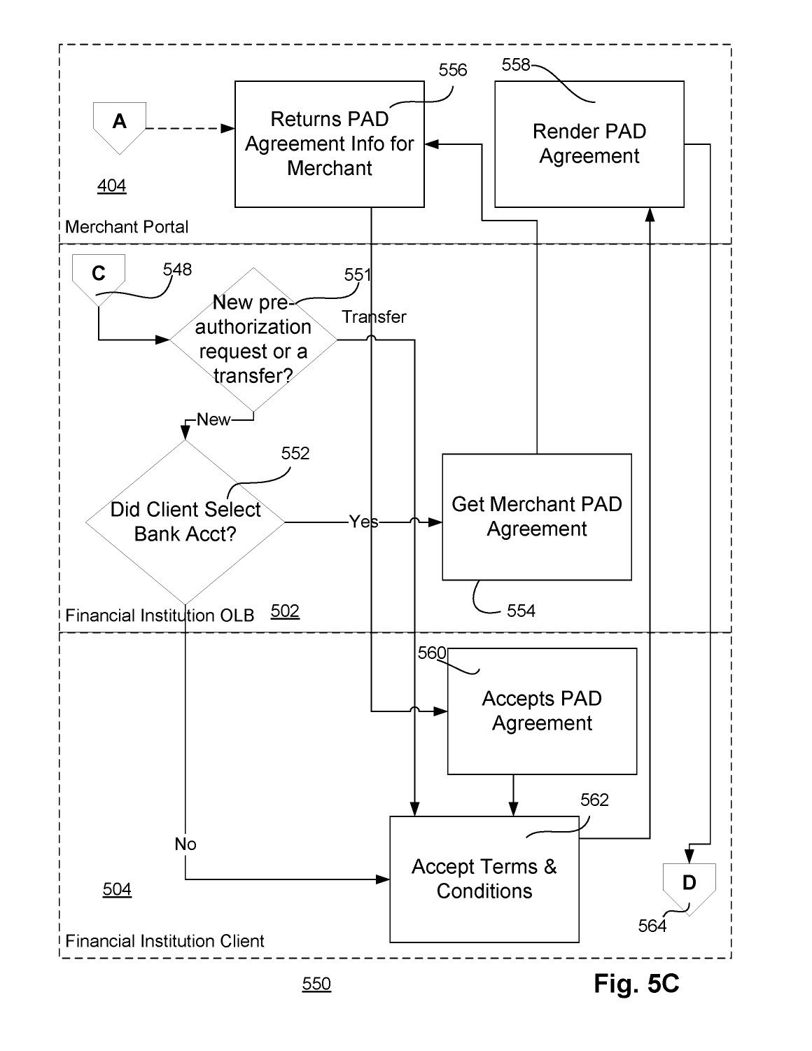

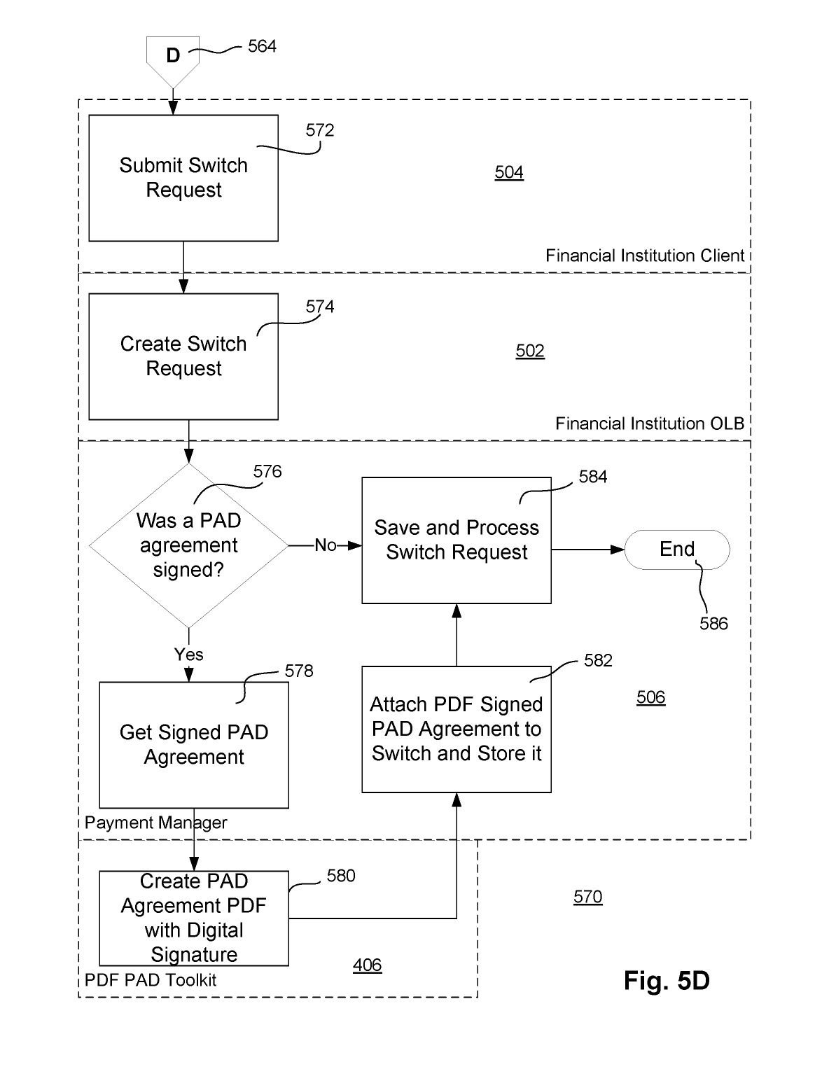

FIGS. 5A to 5D demonstrate a computerized system 500 for activating a PAD agreement by a customer or client. The client computing device 105 running a web browser application (alternatively, a dedicated application may be used), accesses an online banking portal 502 of a financial institution by making an HTTPS request. The online banking portal 502 provides the client computing device 105 with a financial institution client 504 initially displaying a login interface where the client computer 105 may sign in (step 510). Once the client computing device 105 is authenticated, a number of menu items are presented on the display of the client computing device 105. The client may then select payment manager 506 (step 512) which sends a message to the online banking portal 502 where the online banking portal 502 generates a payment manager interface (step 514) by retrieving the client's financial information for display. The payment manager interface may be seamlessly embedded within the user interface of the online making portal 502 (e.g. the payment manager interface appears to be from the financial institution rather than from a third party provider of the service). The payment manager interface may be configured using the financial institution's logos, colors, legal agreements, etc. and in particular may use cascading style sheet (CSS) controls. The client's financial information may comprise a series of deposits and withdrawals to one or more of the client's accounts.

The client computing device 105 displays the interface where the client may choose one of the withdrawals to become a pre-authorized debit or alternatively, the client may choose to set up a new pre-authorized debit without selecting from a list of withdrawals or a list of switch/transfers. The client then chooses from a list of merchants (step 518), each having a merchant identifier, to be associated with the PAD request. The unique merchant identifiers are retrieved from the database server 116. The online banking portal 502 retrieves the merchant details (step 520) by submitting a request to the merchant portal 404 using the merchant identifier. Alternatively, the request may only include a merchant name which is searched in a merchant database by the merchant portal 404 in order to identify a list of potential merchant matches. The merchant database may comprise rules on the payment types and rules associated with the merchant in order to enable timely and accurate payment of the merchant bills.

In yet another alternative, for client computing devices 105 with access to a camera and/or scanner, an image of a merchant statement may be taken and uploaded to the payment manager 506. The payment manager 506 may perform optical character recognition (OCR) on the image using an optical character recognition engine to obtain textual information (or bill data) of the contents of the bill. The merchant may then be searched in a merchant database. If the bill contains a 2D Quick Response (QR) code which was encoded from the information contained in the bill, the QR code may then be decoded to produce the billing information.

The details of each merchant are then requested from payment manager 506. The payment manager 506 executes on the application server 114 and in response to the request for merchant details, retrieves the merchant details including the PAD agreement(s) from a merchant database.

The merchant details are then passed to the online banking portal of the financial institution 502 where the details are processed (step 538). The financial institution OLB 502 displays the accepted payment types based on the type of transaction being completed. The financial institution online banking portal then determines if the client account has one or more acceptable payment accounts (step 540). If no suitable payment accounts are available, a message is displayed on the client computing device 105 reporting that the PAD cannot be setup (step 542) and processing of the PAD is terminated (step 544). Alternatively, an offer to set up a suitable payment account may be displayed. If one of the payment accounts is acceptable, the list of payment accounts is presented on the client computing device 105 for client selection (step 546). The process then continues in FIG. 5C (step 548) where the process determines if a new PAD agreement is being setup or an existing one is being transferred (step 551).

If a new PAD agreement is being setup, the client selects a bank account (step 552), the merchant PAD agreement is requested from the merchant portal 404 by the online banking portal 502 (step 554). The merchant portal 404 retrieves the matching PAD agreement information for the merchant (step 556) and returns it for display within the financial institution client 504 for acceptance by the client (step 560). On acceptance of the PAD agreement the client computing device 105 displays the terms and conditions of the financial institution for acceptance by the client (step 562). If the client selected a transfer at step 551 or selected a non-bank account at step 552, only the terms and conditions are presented for acceptance (step 562). The merchant portal 502 then renders and/or digitally signs and/or encrypts the PAD agreement (step 558). The process then proceeds in FIG. 5D (step 564).

The client computing device 105 presents a prompt to the client requesting submission of the PAD switch (step 572). When the online banking portal 502 receives the switch request, the portal creates a switch request (step 574). The switch request determines the appropriate date to perform the transfer based on known lead times for each merchant and financial institution as further describe in U.S. Pat. No. 7,716,124, herein incorporated by reference in its entirety. The payment manager 506 receives the switch request comprising the PAD agreement and determines if the PAD agreement was signed (step 576). If the PAD agreement was signed, the payment manager 506 retrieves the signed PAD agreement (step 578) and using the PAD toolkit 406, a PDF PAD agreement is generated with a client digital signature (step 580). The signed PDF is returned to the payment manager 506 which attaches the signed PDF PAD agreement to the switch request and/or also stores it in the merchant database (step 582). The switch request is then processed in step 584 for later retrieval by the merchant through the merchant portal 404 and processing terminates (step 586). Alternatively, if the merchant is not a subscriber to the merchant portal 404, the merchant may be notified in the conventional manner described in U.S. Pat. No. 7,716,124 in order to obtain the client signature in another manner.

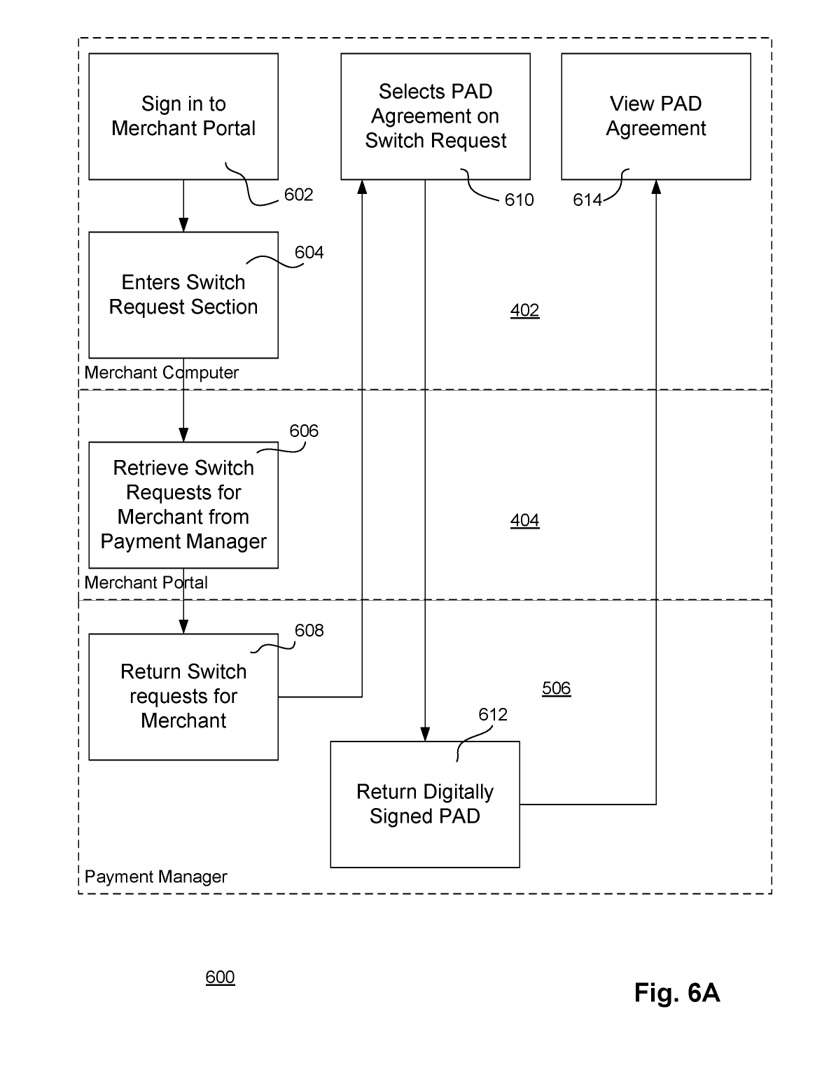

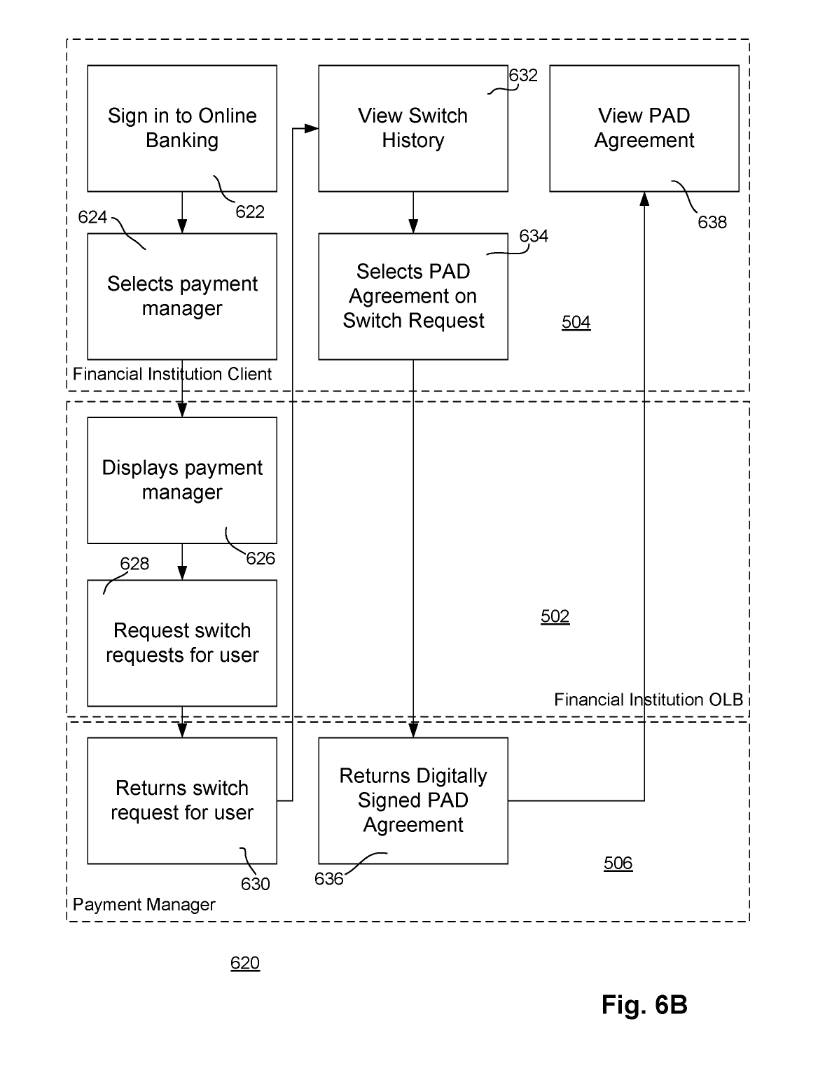

Turning now to FIGS. 6A and 6B, once the switch (or PAD setup) has been stored for retrieval by the merchant via the merchant portal, the merchant, or a particular employee of the merchant, may be notified by email or other form of communication that a switch request is available to be processed by the merchant. The merchant signs into the merchant portal (step 602) using the merchant computer 402 and enters the switch request section of the user interface (step 604). In response, the merchant portal 404 requests pending switches from the payment manager 506 (step 606). The payment manager 506 retrieves the switches from the merchant database and returns a list of pending switches to the merchant computer 402 for display. The merchant then selects one of the pending switches and selects the PAD agreement associated with the switch request (step 610). The request is transmitted to the payment manager 506 which retrieves the digitally signed PAD agreement and returns it to the merchant computer 402. The merchant may then view the signed PAD agreement and complete the switch (step 614).

The client computing device 105 may also be able to view the progress of the switch by signing into the online banking portal 502 (step 622) and selecting the payment manager 506 (step 624) as previously described. The online banking portal 502 generates the payment manager interface and provides it to the financial institution client 504 for rendering (step 626). The online banking portal 502 requests a list of the pending and/or completed switch requests for the client (step 628). The payment manager 506 returns the list of switch requests (step 630). The client computing device 105 then displays the switch history (step 632). The client is then able to view each of the PAD agreements for each switch request by selecting it from the list of switch requests (step 634) which then sends a request to the payment manager 506. The payment manager 506 returns the digitally signed PAD agreement to the client computing device 105 (step 636) where the client computing device 105 displays the PAD agreement on the display (step 638).

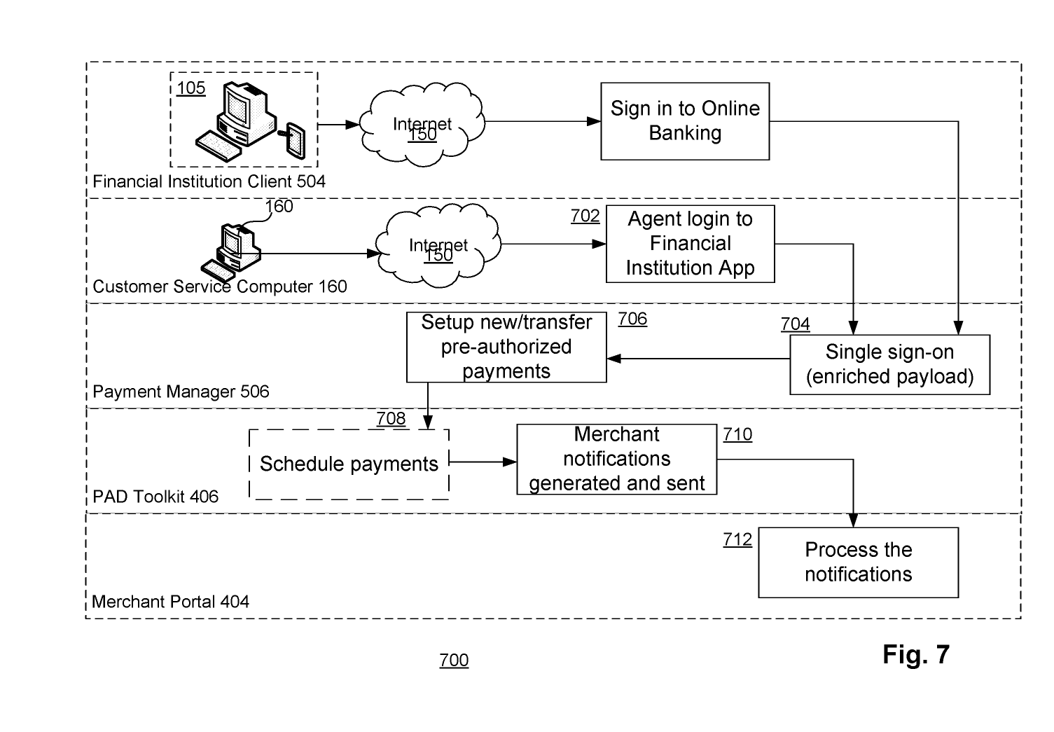

In an alternative embodiment shown with reference to FIG. 7, the client may either perform a self-service pre-authorized debit agreement as previously described or may be assisted by a customer service representative. The customer service representative may receive a call using telephonic means or instant messaging chat from the client computing device 105. The customer service representative may then login to the client's account using a customer service computer 160 (step 702). The customer service representative may verify the authenticity of the client computing device 105 using a passcode or other known form of authentication (step 704). The customer service computer 160 displays a customer service interface whereby the customer service representative may setup a new or transfer an existing pre-authorized payment via an interface similar to the one described for the customer only instance (step 706). Optionally, the customer computing device 105 may mirror the actions of the customer service computer 160 so the customer may verify that the payment is being set up correctly. The date that the pre-authorized payment become active may optionally be scheduled by the customer for a specific start date (step 708). The merchant notifications are generated by the payment manager 506 and sent to the merchants (step 710) where the merchant(s) subsequently processes these notifications (step 712) in order to receive payments.

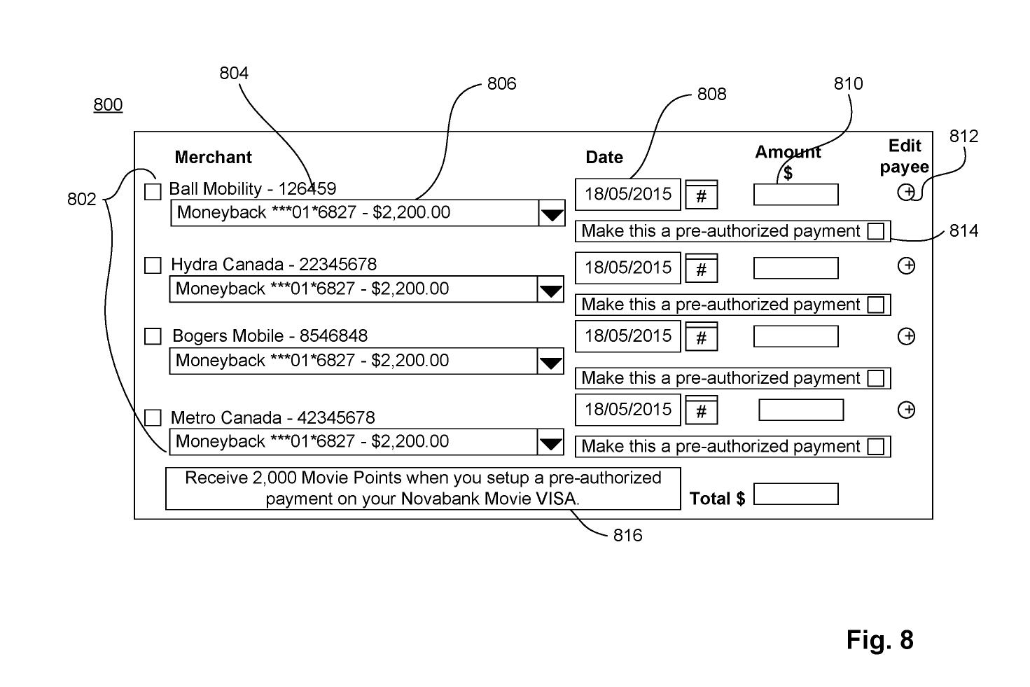

FIG. 8 presents an example client interface 800 showing an online bill payment interface presented on the display of the client computing device 105. A list of merchants 802 is presented with an associated merchant account number 804 and a current payment method 806. Optionally, the effective date of the payment may be manually entered or selected from a popup calendar 808. An amount of payment 810 may be entered. If the payee is incorrect, it may be modified by pressing the edit payee button 812 associated with the merchant. If the payment is able to become a pre-authorized payment, the client may select the “Make this a pre-authorized payment” checkbox 814 which initiates the PAD agreement process as previously described. Optionally, an advertisement 816 may be displayed providing an incentive to the client to initiate a pre-authorized payment for a particular payment card or account. Merchant advertisements may also optionally be displayed.

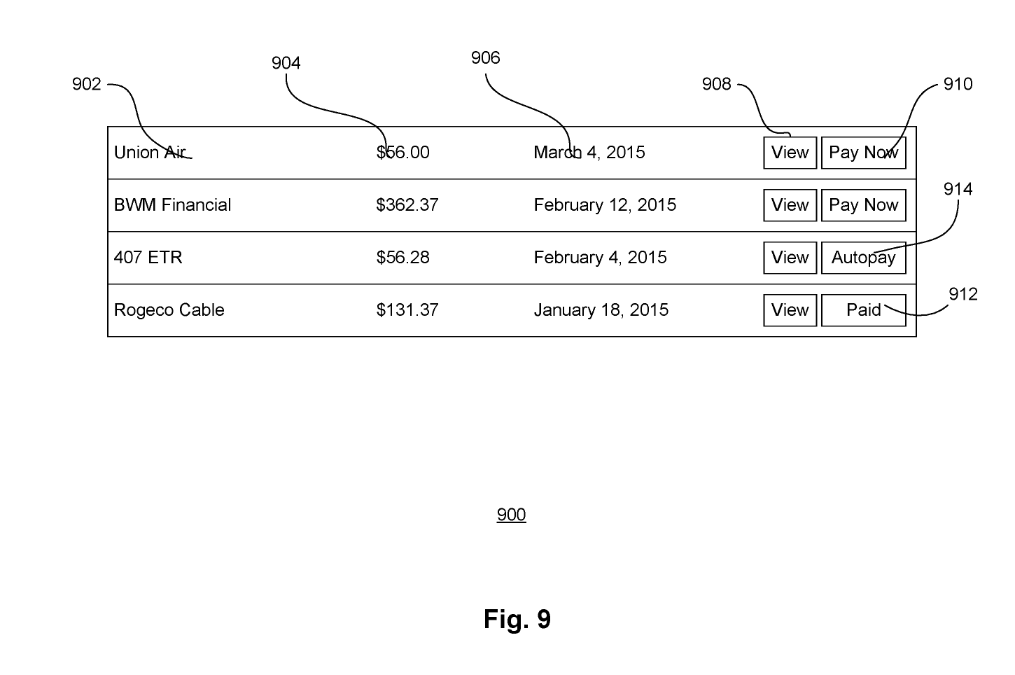

FIG. 9 presents an alternative example client interface 900 of an online bill payment interface on the display of the client computing device 105. Similarly, a list of merchants 902 is presented with an associated amount due 904 and a due date for payment 906. In this example, the client is unable to select the amount or date to pay the bill. If the client wishes to view further details, then the client selects the View button 908. The client may conduct a one-time payment by selecting the “Pay Now” button 910. Bills already paid may display a “Paid” button 912. If the merchant accepts an automatic pre-authorized payment, an autopay button 914 which by selecting initiates a pre-authorized payment process as previously described.

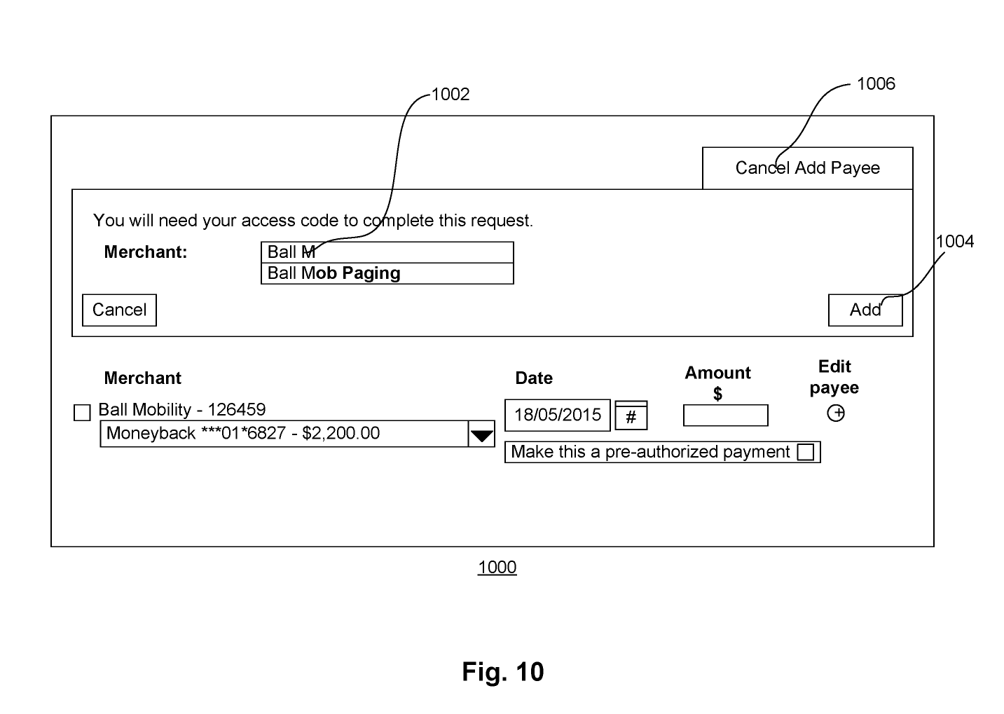

FIG. 10 demonstrates an example client interface 1000 on the display of the client computing device 105 that permits the client to add merchants to pay. The client may search for a merchant to pay using an edit box 1002. Alternatively, the client may also enter an account number or access code in order to complete the request. In some embodiments, the payment manager 506 may automatically parse previous payments associated with the client account and match them to the merchant database. If a match is found, the payment manager 506 recommends setting up a pre-authorized payment via the client computing device 105.

The payment manager 506 accepts XML formatted data (payload) and may contain the following client information: unique customer identifier, previous customer identifier, source financial institution, account holder name (e.g. first and last name), account holder address (e.g. street address, city, province, country, postal code), phone details (e.g. home, home extension, work, work extension, or alternate numbers), language preference, and/or email address(es). Preferably each request transmitted to the payment manager 506 comprises the unique client identifier. The XML formatted data may contain the following customer agent information such as customer service agent identifier, and/or channel (e.g. branch, instant messaging, or telephone banking). The XML formatted data may contain online banking information such as return URL for directing client back to the online banking portal; keep alive URL to keep the online banking portal from logging out due to inactivity enabling seamless navigation ways from the Payment Manager 506 to the online banking portal; and/or campaign code. The XML formatted data may also contain deposit account information such as MICR institution number, transit number, and account number; account type (e.g. chequing, savings, line of credit, other); account display name, account selection name, and/or account reward number. The XML formatted data may also contain credit card information such as credit card number, cardholder name, card expiry month, card expiry year, card type (e.g. Visa, MasterCard, American Express, Visa Debit, Discover, etc.), credit card display name, credit card selection name, credit card reward number, and/or credit card reward description. The XML formatted data may also contain merchant/biller list, such as biller name, biller account number, biller nickname. The XML formatted data may also contain decryption information such as time stamp or encryption type.

In response to the XML formatted data, the payment manager 506 responds with a status code such as for example, OK indicating 100% success; Partial Success indicating that some of the operations were not successful; Bad Request indicating the requested object passed to the operation does not validate properly based on the data type and structural requirements of the passed request; Unauthorized indicating that the client identifier passed is not authorized to access the service (e.g. client identifier is not found or has a compromised account); Forbidden indicating the client is permitted to access the service but not allowed to execute the operation requests; and Server Error indicating that the payment manager 506 is executing but the downstream services are not available or are experiencing error conditions.

In an alternative embodiment, the payment manager 506 may use customer demographics such as for example, postal code, city, product portfolio, to recommend merchants with which other similar customers have pre-authorized payments.

In an alternative embodiment, the payment manager 506 receives fraud data, new credit card data, or new account data from the banking computer and automatically notifies all merchants with pre-authorized debit agreements with that client. The merchant computer then automatically updates all pre-authorized debit agreements to the new information.

In yet another alternative embodiment, the PAD agreement may include other pre-authorized agreements related to credit cards, debit, and other payment card or account types.

These computer programs (also known as programs, software, software applications or code) include machine instructions for a programmable processor, and can be implemented in a high-level procedural and/or object-oriented programming language, and/or in assembly/machine language. As used herein, the terms memory refers to “machine-readable medium”, “computer-readable medium” such as any computer program product, apparatus and/or device (e.g., magnetic discs, optical disks, RAM, ROM, EEPROM, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The systems and techniques described here can be implemented in a computing structure that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet 150.

The computing system can include clients and servers. A client and server are generally remote from each other and typically interact through a communication network. The communication network may be wired, wireless, or any combination thereof. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

The above-described embodiments are intended to be examples of the present invention and alterations and modifications may be effected thereto, by those of skill in the art, without departing from the scope of the invention, which is defined solely by the claims appended hereto.

What is claimed is:

1. A system for reducing memory usage in a pre-authorized debit (PAD) manager comprising:
a networked processing structure comprising a data power appliance executing a web service endpoint;
an application server executing a payment manager; the payment manager retrieving data from a database server storing a plurality of merchant accounts, client accounts, and financial accounts; and
a merchant computer providing a PAD agreement authoring engine for editing a PAD agreement; the merchant computer accessing a merchant portal for retrieving at least one pre-authored clause from the merchant portal; the merchant computer adding at least one reference to the at least one pre-authored clause to the PAD agreement.

2. The system for reducing memory usage in a pre-authorized debit manager according to claim 1, further comprising: the merchant computer creating a merchant signed PAD agreement from the PAD agreement.

3. The system for reducing memory usage in a pre-authorized debit manager according to claim 2, further comprising: the merchant computer uploading the signed PAD agreement to the merchant portal.

4. The system for reducing memory usage in a pre-authorized debit manager according to claim 3, further comprising: the merchant computer associating the merchant signed PAD agreement with a unique merchant identifier.

5. A client computing device comprising:
a processor retrieving and executing instructions from memory;
a user interface communicating with the processor;
a network for communication between the processor and a payment manager;
a camera communicating with the processor;
the memory comprising instructions to cause the processor to:
capture an image of a bill from the camera;
uploading the image to the payment manager over the network;
retrieving a merchant list from the payment manager based at least on the image;
displaying the merchant list on the user interface;
receiving a selection from the merchant list from the user interface;
retrieving a pre-authorized debit agreement from the payment manager; and
retrieving at least one clause from the payment manager based on at least one reference within the pre-authorized debit agreement.

6. The client computing device according to claim 5, wherein the image comprises at least one quick response code encoding bill data.

7. The client computing device according to claim 5, wherein the processor verifies a digital signature of the pre-authorized debit agreement.

8. The client computing device according to claim 7, wherein the processor digitally signs the pre-authorized debit agreement using a client digital signature.

9. The client computing device according to claim 8, wherein the processor transmits the pre-authorized debit agreement signed with the client digital signature to the payment manager.

10. A system for managing pre-authorized debits (PADs) comprising:
a networked processing structure comprising a data power appliance executing a web service endpoint;
an application server executing a payment manager; the payment manager retrieving data from a database server storing a plurality of merchant accounts, client accounts, and financial accounts;
a merchant computer providing a PAD agreement authoring engine for editing a PAD agreement; the merchant computer accessing a merchant portal for creating a merchant signed PAD agreement from the PAD agreement; and
associating the merchant signed PAD agreement with a unique merchant identifier.

11. The system for managing pre-authorized debits according to claim 10, further comprising: a bank server communicating with the networked processing structure over a network.

12. The system for managing pre-authorized debits according to claim 11, wherein the network is secured by a virtual private network.

13. The system for managing pre-authorized debits according to claim 11, further comprising: a client computing device accessing the banking server; the client computing device configured to pay at least one merchant bill from at least one client account.

14. The system for managing pre-authorized debits according to claim 13, further comprising: the client computing device setting up the at least one merchant bill as a pre-authorized debit.

15. The system for managing pre-authorized debits according to claim 14, further comprising: the client computing device retrieving the merchant signed PAD agreement.

16. The system for managing pre-authorized debits according to claim 15, further comprising: the client computing device digitally signing the merchant signed PAD agreement; and returning the digitally signed merchant agreement to the payment manager.

17. The system for managing pre-authorized debits according to claim 10, further comprising: an agent computer accessing the online banking system communicating with the networked processing structure.

18. The system for managing pre-authorized debits according to claim 13, wherein:
the agent computer accesses the at least one client account to assist in the setup of the pre-authorized debit.

19. The system for managing pre-authorized debits according to claim 16, further comprising: the payment manager initiating a recurring debit based on one or more terms of the PAD agreement by transmitting the digitally signed merchant agreement to the merchant computer.
